(19) United States
(12) Patent Application Publication
(10) Pub. No.: US 2016/0300030 A1
(43) Pub. Date: Oct. 13, 2016

(54) SYSTEM, METHOD, AND COMPUTER PROGRAM FOR SUPPLYING MEDICAL EQUIPMENT SUPPORT

(71) Applicant: MEDPRODIGY, INC., OVERLAND PARK, KS (US)

(72) Inventors: ROBERT E. VANN, JR., SHAWNEE MISSION, KS (US); ROBERT PEARCY, LIBERTY, MO (US)

(73) Assignee: MEDPRODIGY, INC., OVERLAND PARK, KS (US)

(21) Appl. No.: 15/094,640

(22) Filed: Apr. 8, 2016

Related U.S. Application Data
(60) Provisional application No. 62/144,724, filed on Apr. 8, 2015.

(51) Int. Cl. G06F 19/00; G06F 3/038; H04N 7/14; G06T 19/00; H04N 5/77; H04N 7/15

(52) U.S. Cl. CPC G06F 19/3418; H04N 5/77; H04N 7/15; H04N 7/141; G06T 19/006; G06F 3/038

(57) ABSTRACT

A system for providing medical equipment support to a hospital physician, the system comprising a remote server system for storing medical equipment information, a number of remote support terminals each including video and audio input and output components for allowing remote medical equipment support representatives to communicate with the hospital physician and provide medical equipment information to the hospital physician, and on-site support portals each including video and audio input and output components for allowing the hospital physician to communicate with the remote medical equipment support representatives and provide context of medical procedure to the medical equipment support representatives in real time.

### RELATED APPLICATIONS

This application is a non-provisional patent application and claims priority benefit with regard to all common subject matter, of earlier-filed U.S. Provisional Patent Application Ser. No. 62/144,724 filed on Apr. 8, 2015, and entitled “SYSTEM, METHOD, AND COMPUTER PROGRAM FOR SUPPLYING MEDICAL EQUIPMENT SUPPORT”. The identified earlier filed provisional patent application is hereby incorporated by reference in its entirety into the present application.

### FIELD

Embodiments of the present invention provide a system, method, and computer program for allowing a remotely located medical equipment sales or technical representative or other medical equipment, device, or system expert (e.g., a specialist in a particular system, technique, device, equipment, or tool; a supplier technical representative; an academic faculty physician; or a designated or recognized physician authority) to provide expertise relating to medical equipment used during medical procedures to an on-site physician via video, audio, and/or virtual reality representations transmitted over a wireless communication network.

### BACKGROUND

Medical procedures require due diligence, competence, and informed consent. This extends to medical equipment used during medical procedures and decisions related to the use of the medical equipment. Medical due diligence encompasses the reasonable steps taken by medical personnel to satisfy a predetermined medical legal standard of care. For example, a physician must determine that a patient is not allergic to a particular medicine before prescribing the medicine to the patient. Competence in relation to the practice of medicine requires a heightened level of expertise or training of medical personnel to practice or assist in the practice of medicine. Informed consent requires that patients agree to a particular medical course of action based upon a clear appreciation and understanding of the facts, implications, and consequences of the course of action.

Medical equipment may include surgical tools, electronic equipment, disposables, safety equipment, medicine, implants, and the like. Decisions related to the use of medical equipment include the decision to use or not to use a particular piece of equipment for a particular medical procedure, and the selection of a particular type, model, brand, or supplier of equipment. Physicians, surgeons, nurses, and other hospital personnel rely on sales or technical representatives (hereinafter “medical equipment support representatives”) of medical equipment suppliers to provide guidance, expertise, knowledge, and education relating to medical equipment used during medical procedures (i.e., “medical equipment support”). Supplier technical expertise is particularly helpful to the physician and operative support staff when intra-procedural actions require a deviation from or an improvisation of current published technical guides or unpublished actions. Access to this expertise limits medical legal liability for the hospital and physician, while suppliers incur additional exposure related to product liability and errors and omissions implications, with several ambiguities still existing with regard to FDA Act compliance issues. For example, one issue may be “Is a given application that supplier expertise is being provided for being conducted in an FDA Act compliant manner and are the procedure related peripherals and product inserts supplied by the supplier or their on-site representative in compliance with the requirements of FDA Act for procedure related disclosures?”

Medical equipment support introduces additional due diligence, competency, and informed consent issues on top of the legal issues related to the physician's practice itself. For example, one or more supplier equipment systems (e.g., a line of medical products, a surgical tool kit, or array of potentially useful implants) are often used during the medical procedures. A single supplier equipment system may include as many as ten trays containing over thirty instruments each, a number of additional disposables, and over one hundred potential implant combinations. Supplier sales or technical representatives are typically responsible for as many as fifty equipment systems. With each system being in a continual state of technological evolution, it's unrealistic for any supplier representative responsible for more than a single system to be intuitively knowledgeable and reflexively conversant about the intricacies, entirety of options, cause and effects of technique related actions which represent the performance standard physician and engineer designers built into the system and continue to make efforts to enhance performance by routine implant and instrument additions. With supplier technical representatives usually busy preparing for or covering procedures, this leaves them little time for quantitative development or for developmental time where experts more knowledgeable on a particular system can routinely quantify and validate the supplier technical representatives system competency. No reliable, quantifiable, standard exists for evaluating and ensuring representative competency, particularly when unpredicted intra-procedural conditions encountered by the operating physician require immediate improvisation.

In addition to being subjected to the logistical issues involved with managing equipment systems, hospitals and other medical entities are often faced with choosing between various and imperfect supplier distribution models. For example, hospitals may utilize on-site supplier sales and technical representatives to master the intricacies of the many systems for the various medical procedures that their principal medical equipment company assigns them with representing. Many on-site representatives are required to be available to support physicians and hospital personnel in multiple locations, even when procedures are being performed almost simultaneously at different hospitals leaving very clear potential case preparation and intra-procedural assistance voids.

An option available to more procedurally specialized hospitals is to charge the hospital personnel themselves with mastery of the equipment options and procedural options related to their specialty. Yet another option is to place no emphasis or focus on system-specific technical representation at all. As such, hospitals and other medical entities presently cannot ensure due diligence and uniform competency for medical equipment support. On-site representatives also may present risks within the medical procedure room such as being an additional infection source. Also, additional bodies in an already crowded and hectic and very small surgical suite may add to the confusion or may get in the way, adding to HIPAA compliance exposure, informed consent exposure, and other medical legal exposures described above.

### SUMMARY OF THE INVENTION

Embodiments of the present invention solve the above-mentioned problems and provide a distinct advance in the art of supplying medical equipment support and medical equipment information to hospitals and other medical entities. More particularly, the present invention provides a medical equipment support system whereby remote medical equipment representatives may provide medical equipment information and support to physicians and other hospital personnel in real time over a wireless communication network via on-site support portals and remote support terminals.

An embodiment of the present invention is a medical equipment support system for providing remote medical equipment support to a hospital physician in real time. The system broadly comprises remote support terminals and on-site support portals. The remote support terminals each include output components for presenting video and audio of a medical procedure being performed at the hospital to a remotely located medical equipment support representative. The remote support terminals also each include input components and a transceiver for transmitting video and audio of the medical equipment support representative to the medical treatment room. The on-site support portals each include output components for presenting the video and audio of the medical equipment support representative to the hospital physician and input components for transmitting the video and audio of the medical procedure to the medical equipment support representative. This allows the hospital physician to receive medical equipment information from the medical equipment support representative according to the medical procedure being performed without the medical equipment support representative being present in the medical treatment room.

Another embodiment of the present invention is a method of providing remote medical equipment support to a hospital physician in real time via a medical equipment support system. The method includes transmitting video and audio of a medical procedure being performed in a medical treatment room to a remotely located medical equipment support representative via an on-site support portal. The video and audio may be presented to the remotely located medical equipment support representative via a remote support terminal. Video and audio of the medical equipment support representative may also be transmitted to the medical treatment room via the remote support terminal. The video and audio of the medical equipment support representative may then presented to the physician via the on-site support portal. In this way, the hospital physician may receive medical equipment information from the medical equipment support representative according to the medical procedure being performed without the medical equipment support representative being present in the medical treatment room.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic view of a medical equipment support system constructed in accordance with an embodiment of the present invention;

FIG. 2 is a schematic view of an information network connecting together a third party medical information and medical standards company, a number of hospitals, and a number of medical equipment supplier representatives via the medical equipment support system of FIG. 1;

FIG. 3 is a schematic view of a remote support terminal of the medical equipment support system of FIG. 1;

FIG. 4 is a schematic view of an on-site support portal of the medical equipment support system of FIG. 1; and

FIG. 5 is a flow diagram of a method of providing remote medical equipment support.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present invention ensure that hospitals, supplier sales and technical representatives, and disseminated information conform to a uniform standard of care and ensure that risks are acknowledged, quantified, minimized, and dealt with appropriately in the event that an adverse event occurs (i.e., “risk algorithms”), and that these risk algorithms are documented. The Pike medical legal standard of “knowledge commensurate with comparably trained professionals” is the accepted medical standard but its application to specific techniques, equipment, and representative guidance is unclear. Embodiments of the present invention establish a de facto standard of care, which can be met and is evidenced by utilizing the invention.

Physicians apply a risk algorithm that best fits their needs (e.g., “technique specific” or “device specific” algorithm). Technique specific risk algorithms are viewed from a non-device perspective, which are applicable where no device is involved or the device of choice in no way influences procedural planning. Device specific risk algorithms blend procedural planning and technique considerations when the device of choice influences either. Embodiments of the present invention allow the physicians to validate their risk algorithms.

Suppliers/representatives may utilize embodiments of the present invention to “process map” processes and actions in conjunction with peer recognized physician thought leaders on a specific technique and system, or independently by physician thought leaders. Efforts to implement the appropriate peer recognized authority's plan and then following and documenting these efforts will become evidence of meeting the appropriate standard of care for due diligence and informed consent.

Embodiments of the present invention present various levels of assistance desired by the equipment supplier/representative, physician, and hospital. A first level represents the ability for the representative to remotely coordinate technical and procedure support. This allows the representatives to unobtrusively visualize and communicate with hospital personnel precisely and in real time, utilizing any one or a mix of communication modes which are most effective and when appropriate to assure physician and procedural relevant hospital staff of reliable suppler/representative performance. The first level meets a minimum standard for maximizing global procedural quality.

A second level adds a digital suite of supplier system enhancing tools that allow suppliers to digitally deliver the most current versions of technical manuals, procedure reference peripherals, and current risk inserts to the physician. The information is disseminated in an FDA Act compliant manner and Sunshine Act exempt reporting format while documenting the specific versions delivered.

A third level provides access to templates for standard of care, due diligence, and informed consent from a third party medical information or medical standards company. The third party company may provide technique specific or supplier specific risk reduction algorithms, as described above. Templates of these algorithms are available in real time and are customizable for each patient.

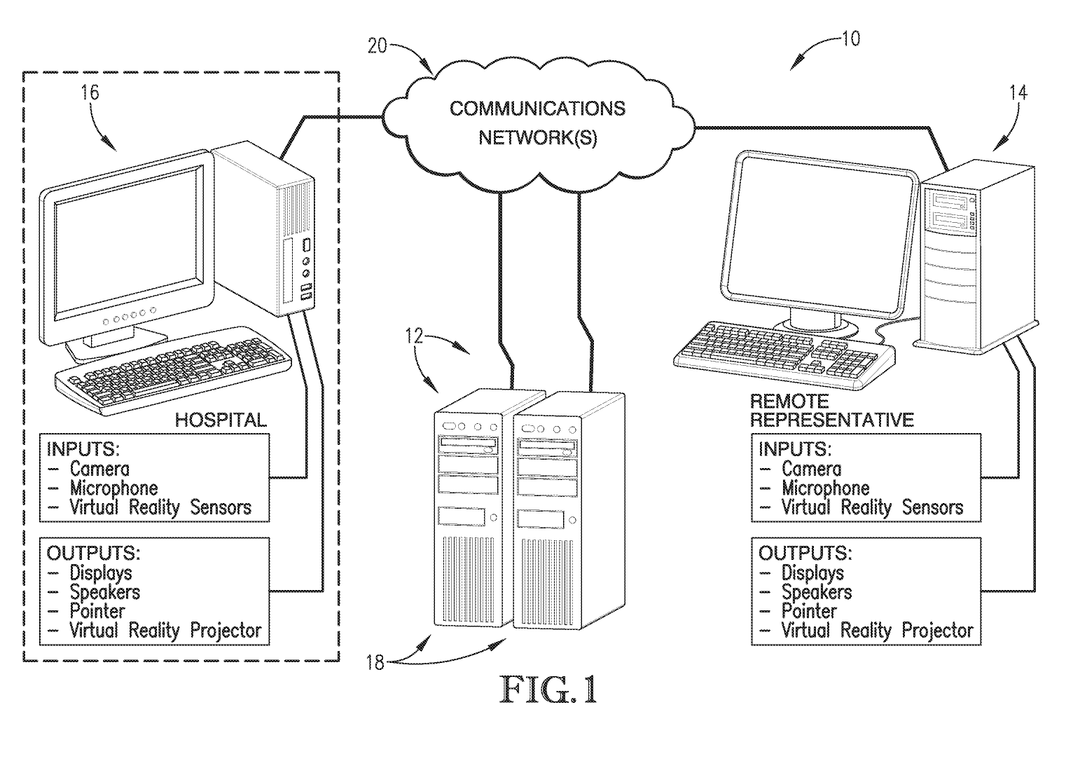

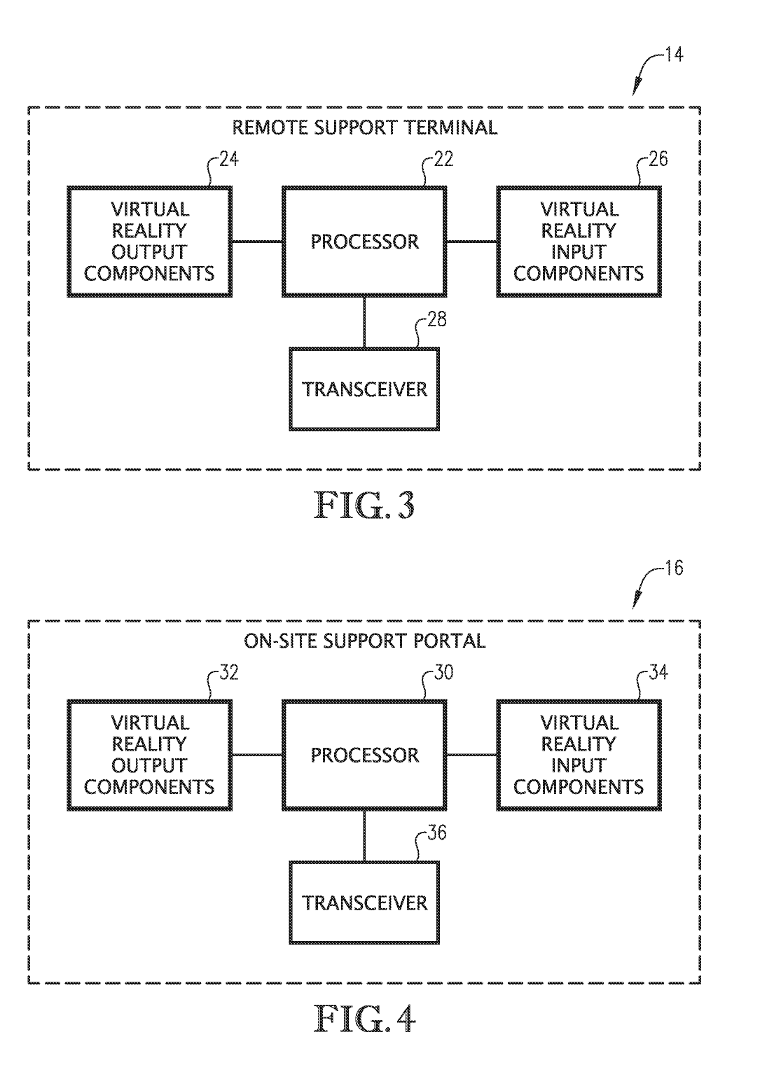

With reference to the drawing figures, the present invention provides various embodiments of a system 10, method, and computer program for providing uniform, accessible, and quantifiably reliable medical equipment support to physicians, doctors, surgeons, and other hospital personnel. The medical equipment support system 10 broadly comprises a remote server system 12, remote support terminals 14, and on-site support portals 16, as shown in FIGS. 1-4.

The remote server system 12 stores technical equipment information for equipment of various equipment suppliers, medical procedure information, medical education information, electronic medical records (EMR), medical legal information, and other information and includes remote servers operated or provided by a third party medical information and medical standards company. The remote server system 18 may host a website or information repository accessible over a wireless communication network 20 by the equipment suppliers and/or medical personnel that have accounts or contracts set up with the third party company for facilitating communication and possible physician remuneration in an FDA Act compliant and Physician Sunshine Act reporting exempt manner and access to treatment related reference peripherals in an FDA Act, Anti-kick Back Statute, False Claims Act compliant format, and Physician Sunshine Act exempt reporting manner.

Embodiments of the remote server system 18 may run Windows; LAMP (Linux, Apache HTTP server, MySQL, and PHP/Perl/Python); Java; AJAX; NT; Novel Netware; Unix; Mac OS; or any other software system. The remote server system 18 may include or have access to computer memory and other hardware and software for receiving, storing, accessing, and transmitting information via the wireless communication network 20. The remote server system 18 may also include conventional web hosting operating software, searching algorithms, and an Internet connection, and may be assigned URLs and corresponding domain names so that they can be accessed via the Internet in a conventional manner.

The remote server system 12 may run software for presenting the technical equipment information, medical procedure information, medical education information, electronic medical records (EMR), medical legal information, and other information to physicians and other medical personnel via corresponding graphical user interfaces in context with required or optional practices, routines, and medical procedures, as described below.

The wireless communication network 20 is preferably the Internet but may be any other wireless communication network such as a local area network, a wide area network, or an intranet. The wireless communications network 20 may include or be in communication with a network capable of supporting wireless communications such as the wireless networks operated by AT&T, Verizon, or Sprint. The wireless communication network 20 may also be combined or implemented with several different networks.

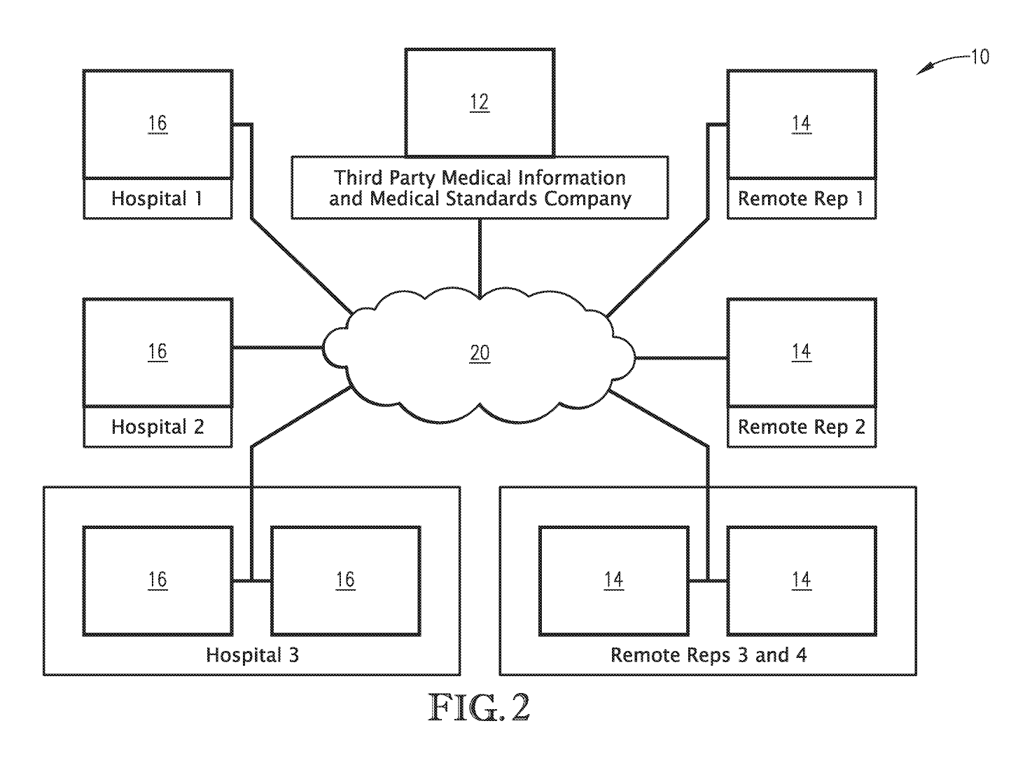

The remote support terminals 14 allow medical equipment representatives, technical representatives, and supplier physician experts to provide equipment and procedure support to medical personnel performing medical procedures at different hospital locations one after the other or even simultaneously, as shown in FIG. 2. The remote support terminals 14 each may include a computer having a processor 22, audio, visual, and virtual reality output components 24, audio, visual, and virtual reality input components 26, and a transceiver 28 for communicating over the wireless communication network 20. For example, the computers may have a display screen, speakers, and virtual reality projection components for allowing the representatives to perceive events and actions occurring in one of the medical treatment rooms and a video camera, a microphone, a pointer, and virtual reality input components 26 (e.g., virtual reality cameras and sensors) for picking up movement and actions of the representative. The remote server terminals 14 may be located remotely from each other so that representatives from separate companies, locations, and areas of expertise may interact with physicians and each other during a medical procedure, as described below.

The display screen may show the patient and medical equipment as seen from the doctor's perspective or third person perspective (captured via cameras described below) to the representative. The speaker may broadcast audio received from the medical treatment rooms such as the physician's and patient's voices in a HIPAA compliant manner. The virtual reality projection components 24 may project two dimensional or three dimensional effects representing physical objects from the medical treatment room so that the representative may interact with the projections as if he was in the medical treatment room. All of these sensory outputs may be received in substantially real time so that the representative may communicate and interact with the physician as if he was in the medical treatment room.

The video camera may capture video of the representative's face, hands, and/or remote medical equipment for transmission to the medical treatment room. The microphone may capture the representative's voice and other audio. The pointer may include any kind of tracking device such as a laser pointer, wand, or computer mouse for allowing the representative to point to objects in the medical treatment room or positions on the patient. The virtual reality input components 26 may capture movement of the representative's face, hands, and/or remote medical equipment for projecting as two dimensional or three dimensional projections into the medical treatment room, as described below.

The on-site support portals 16 present the video, audio, pointer, and/or virtual reality representations from the remote support terminals 14 into the medical treatment room and each may include a computer having a processor 30, audio, visual, and virtual reality output components 32, audio, visual, and virtual reality input components 34, and a transceiver 36 for communicating over the wireless communication network, as described above. For example, the computers may have a display screen, speakers, and virtual reality projection components for allowing the physicians to perceive events and actions performed by the remotely located representative and a video camera, a microphone, a remote controlled pointer, and virtual reality input cameras and sensors for capturing movement and actions of the physician(s) and/or patient. Multiple display screens may be provided for multiple field viewing. The video camera and/or microphone may be fixed to a medical room, bed, or other fixture, as opposed to being worn by a physician or other personnel, so as to relate captured video and/or audio recordings to the room or fixture and not to the personnel. This allows recordings to more easily be catalogued and allows video recordings of different patients to remain separate because physicians and hospital staff often attend to more than one patient in short amounts of time. Multiple medical professionals and hospital staff may also have encounters with a single patient in the same recording.

The display screen may show the representative (captured via cameras described below) to the physician. The speaker may broadcast audio received from the representative for communicating therewith. The virtual reality projection components may project two dimensional or three dimensional effects representing physical medical equipment, implants, and other objects for reference by the physician. All of these sensory outputs may be received in substantially real time so that the physician may communicate and interact with the representative as if the representative was in the medical treatment room.

The video camera may capture video of the physician's face and hands, on-site medical equipment, and the patient for transmission to the representative. The microphone may capture the physician's voice, medical equipment alerts, and other audio. The remote controlled pointer may include any kind of tracking device such as a laser pointer or wand for pointing at medical equipment or points of interest on the patient as directed by the representative. That is, the remote controlled pointer may be controlled via the pointer manipulated by the representative. The virtual reality sensors may capture movement of the physician's face, hands, and/or medical equipment for projecting as two dimensional or three dimensional effects at the remote support terminals 14.

The remote server system 12, remote support terminals 14, and on-site support portals 16 each may run a computer program or programs for implementing certain steps of the present invention as described herein. Portions of the computer program stored on memories of the computer systems can be updated via a computer readable medium, the wireless communication network 20, or a manual connection. Therefore, the computer program as described herein is to be understood as all code segments, either individually or collectively, that are executed to implement the steps and features of the present invention.

The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium include the following: an electrical connection having wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via optical scanning of the paper or other medium, then compiled, interpreted, or otherwise processed in a suitable manner, if necessary, and then stored in a computer memory. The various actions and calculations described herein as being performed by or using the computer program may actually be performed independently or cooperatively by computers, processors, or other computational devices.

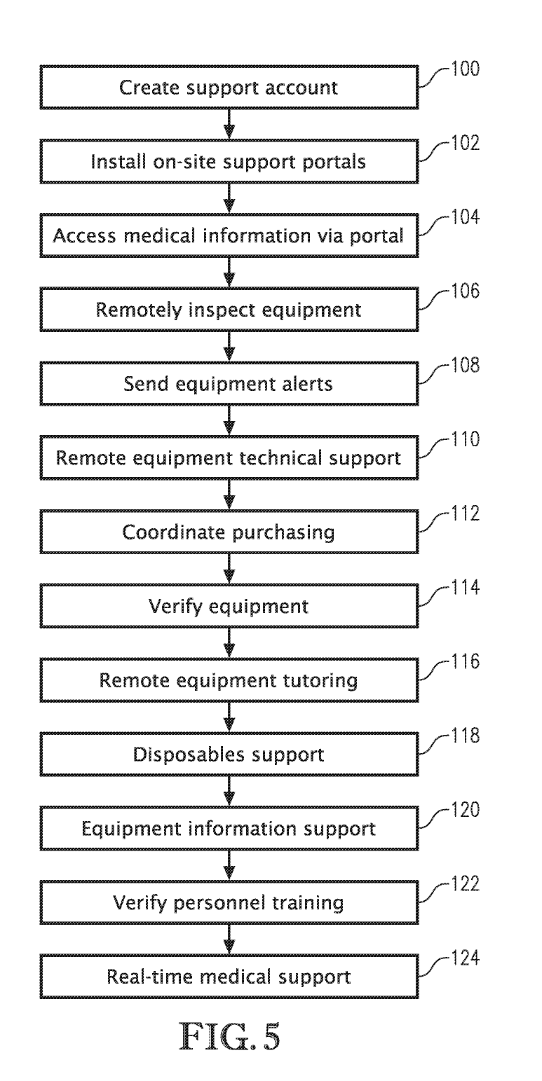

Use of the medical equipment support system 10 will now be described in more detail. Hospitals and other medical entities may create accounts or enter into a contract with the third party medical information and medical standards company for access to the information stored on the remote server system 12, as shown in block 100 of FIG. 5. The accounts may be tiered or packaged so that access to specific information, equipment representatives, and features of the on-site support portals 14 may be partitioned or upgraded according to account subscription levels or according to the hospitals' areas of practice.

The on-site support portals 14 may be installed in medical treatment rooms and related locations and linked to the remote server system 12 and remote support terminals 14 over the wireless communication network 20, as shown in block 102. For example, each operating room and examination room of the hospital may have an on-site support portals for providing equipment support thereto.

Physicians performing medical procedures and checkups on patients may use the on-site support portals 16 to access the technical equipment information for equipment of various equipment suppliers, medical procedure information, medical education information, electronic medical records (EMR), medical legal information, and other information stored on the remote server system 12, as shown in block 104. Physicians may also communicate with remotely stationed medical equipment representatives in real time. At any time, the on-site support portals 16 may retrieve and display relevant medical information, patient medical records, medical legal information, and medical equipment information from the remote server system 12 corresponding to the procedure and specific steps being performed. The on-site support portals 16 may be linked to remote support terminals 14 for providing remote equipment representative support between and during medical procedures.

Before or between medical procedures, the representative may remotely view and inspect equipment trays and other equipment inventory to ensure that instruments and implants are complete, assembled correctly, not out of stock or missing any items and are in proper condition before the medical procedure is begun, as shown in block 106. For example, a camera of an on-site support portal 16 may be trained on the equipment trays. Optionally, an on-site assistant may open or move the trays so that the representative can clearly see the equipment with one option, the ability to utilize the remote controlled laser aiming device to assist surgical or Sterile Processing and Distribution staff with tray identification, instrument identification, instrument layout and assembly tips to relieve the burden of system related expertise from hospital human capital. The representative may then verbally, visually, or virtually indicate which equipment is missing and instruct the assistant to restock the equipment trays accordingly or to take the appropriate course of preparation or procedure related action.

The on-site support portals 16 may track the use of equipment via the camera and may automatically alert hospital personnel to restock the equipment trays or to clean the equipment accordingly, as shown in block 108. The alerts may be integrated into an operation, examination, or maintenance checklist or application such that hospital personnel restock the equipment trays or clean the equipment as part of a routine procedure.

The representative may assist the physician or scrub nurse in determining an appropriate template or creating a template for a procedure in advance of the procedure and other remote equipment technical support, as shown in block 110. The representative may also assist in predetermining implant needs, identifying potential technical nuances of the equipment or implants in advance of the procedure, and identifying alternative procedure requirements.

The representative may then coordinate with the hospital purchasing department via the support system 10 and may obtain a purchase order to list the items likely to be utilized, as shown in block 112. Purchasing may also be performed automatically based on collected purchasing data, hospital inventory data, and scheduled medical operations and procedures.

The representative may also verify that all equipment and implants are stocked, sterilized, and ready within the expectation established by the physician or the hospital of the start of the procedure, as shown in block 114. The support system 10 may collect timestamps and other data corresponding to the verification such as representative name and position.

The representative may then tutor on-site nurses and other hospital personnel on instrument sequence, location, recognition, assembly, and technical effects of each device prior to the procedure, as shown in block 116. Tutoring may be performed during the course of work or in separately scheduled tutoring sessions.

The representative may also identify proper disposables and the related technical effects of the use of each, as shown in block 118. Hospital personnel may be tutored on disposables information similar to the instrument tutoring described above.

The representative may then verify that pertinent technical materials such as technical manuals, risk inserts, dimensions, specifications, illustrations, templates, and other information disseminated by the support system 10 are available through the on-site support portals 16 and up-to-date, as shown in block 120. The support system 10 may document that the most current versions of information are disseminated.

The representative may then verify that physician and hospital nurses are knowledgeable about reasonable alternative procedures and potential additional procedures, as shown in block 122. The support system 10 may collect timestamps and other data corresponding to the verification such as representative name and position and names of the trained hospital personnel.

The representative may then communicate and interact with the physician and hospital nurses during the medical procedure to provide technical guidance in real time as if the representative was in the medical treatment room, as shown in block 124. This provides the benefit of the expertise of the representative without extra personnel in the medical treatment room.

In one embodiment, the on-site support portals 16 may project a medical equipment tray or implant template or layout on a screen or wall, over the real instruments themselves, or other sterile or non-sterile fields for the physician to reference as the representative explains the uses of the instruments shown. The representative may point to a desired medical instrument or implant shown on the template via the pointers and/or virtual reality components as he explains the uses of the instrument. In other embodiments, the on-site support portals 16 may project medical equipment or implant reference images or projections as initiated by the representative for the physician to reference when performing medical procedures.

The representative may manipulate virtual reality projections within the medical treatment room and on the patient to demonstrate proper techniques, uses, and medical procedures. For example, the representative may explain an instrument's or implant's uses or recommend its use to the physician as the physician performs a procedure. The representative may also demonstrate the instrument or implant's uses via video or virtual reality manipulation of an instrument or implant projection. Furthermore, the representative may point out, via the pointers, templates, or virtual reality projections, various options in technique or equipment to the hospital personnel and have the personnel prepared one or more steps in advance of what the physician is likely to request.

The on-site support portals 16 may maintain copies of the quantity of all catalog and lot code numbers utilized and may make the copies available to the circulating nurse at the time of use and summarily at the conclusion of the procedure. The on-site support portals 16 may also record and store the medical procedures performed and remote equipment support provided and/or transmit the video and audio or recording to the remote server system 12 for storing therein so as to retain evidence that the physician, hospital, and representative followed proper protocol, performed sufficient due diligence, and operated at a predetermined standard of care.

The representative may then verify that all non-sterile disposables and implants are removed or thrown away properly after completion of the medical procedure. The representative may also verify that certain instruments are taken immediately to the sterile processing department (SPD) for cleaning. The representative may then ensure that instruments, disposables, implants, and technical materials are returned or prepared for the next procedure and may order any equipment that is not stocked or is missing. To do so, the representative may coordinate with the materials management department via the support system 10.

The physician may be provided access to patient diagnostic aides using embodiments of the present invention. Scaled schematics of supplier implant or device options may be overlaid with the most recent patient diagnostic aide for device option assessment, surgical technique selection, device site preparation, and procedural related needs anticipation. Supplier device schematics may be made available to the physician and staff. Alternatively, patient diagnostic related deliverables may be made available to the technical representative via embodiments of the present invention for performing any appropriate estimations. The physician may then review the estimates to determine validity. This helps prove physician and hospital due-diligence, decreases procedure time for the suppliers, and increases physician satisfaction with the supplier system.

Access to patient diagnostic aides assures accuracy at the earliest stages possible and prevents exponentially increasing medical complications. For example, prolonging the length of a procedure needlessly exposes a patient to anesthesia and other procedure related health perils. Leg length discrepancies can result in gait related deficiencies, which have a chain of potential effects, e.g., new or exacerbated existing spinal and weight bearing extremity symptoms, some of which require additional medical procedures for correction. Less than ideal execution or improper planning of spine related procedures may result in reduced quality of life and other symptoms. Inaccurate planning for any extremity may impact the stability of tissue or mechanical constructs which can impede the normal healing process, resulting in a complete failure to heal and/or device failure.

The support system 10 may capture a partial or complete audio and/or visual recording of the physician/patient engagement. The support system 10 may instantly or immediately encrypt or scramble the recording data at the time of recording to protect the patient's privacy as required by HIPAA or other privacy standard or law. As such, the data may never exist, or may exist for only a short time in a limited location with limited access, in a discernable format that would allow it to be associated with an individual patient. The data may be maintained in the encrypted format for the life of its existence, further protecting the patient's privacy. Should the data set need to be made available to a patient's caregiver, such as a caregiver defined under HIPAA, the data may be transferred in a fully encrypted data format and may only be descrambled or decrypted for review by the patient's caregiver via a unique code associated with the specific physician/patient engagement.

The above described invention provides many advantages over the prior art. For example, the support system 10 provides evidence of, and support for, due diligence, informed consent, conflict of interest compliance and other medical legal issues such as FDA Act compliance including utilizing a format that allows physicians access to treatment options of all types in an FDA Act compliant manner and allowing suppliers to fulfill their FDA Act obligations to provide the most current versions of FDA approved risk insert and product utilization protocols. The support system 10 establishes a process for documenting physicians initiating requests for information about the application of a supplier's product for use in a manner not yet approved by the FDA. The support system 10 also allows physicians to document professional and patient consideration of all relevant treatment options in compliance with the False Claims Act. The support system 10 further allows medical content providers to be remunerated in an FDA Act compliant manner (e.g., Anti-kickback statute compliant manner), that is, a manner that does not disproportionately reward faculty or editors for emphasizing a particular supplier or treatment option and provides a “treatment specific” or “patient referral” disclosure mechanism that informs of potential conflict of interest in addition to providing a list of treatment or referral sources where no conflict of interest exists. In addition, the support system 10 encrypts the recording data at the time of recording to protect the patient's privacy as required by HIPAA or other privacy standard or law. The support system 10 also ensures product liability compliance (e.g., current product risk, product utilization protocols and product utilization and planning media related peripherals compliance) and documentation processes. The support system 10 provides these features in a single digital platform.

Although the invention has been described with reference to the embodiments illustrated in the attached drawing figures, it is noted that equivalents may be employed and substitutions made herein without departing from the scope of the invention.

Having thus described various embodiments of the invention, what is claimed as new and desired to be protected by Letters Patent includes the following:

1. A system for providing medical equipment support to a hospital physician performing a medical procedure on a patient in a medical treatment room, the system comprising:
a remote support terminal including:
an output component configured to present video and/or audio of the medical procedure to a remotely located medical equipment support representative;
an input component for capturing medical equipment information produced by the medical equipment support representative; and
a transceiver for transmitting the medical equipment information to the hospital physician over a wireless communication network; and
an on-site support portal including:
an output component configured to present the medical equipment information to the hospital physician;
an input component for capturing video and/or audio of the medical procedure; and
a transceiver for transmitting the video and/or audio of the medical procedure to the medical equipment support representative over the wireless communication network such that the hospital physician is provided medical equipment information and medical equipment support as the medical procedure is being performed.

2. The system of claim 1, further comprising:
a remote server system including:
a processor for hosting a medical support website, the processor being configured to communicate with the remote support terminal and the on-site support portal over the wireless communication network; and
a memory component for storing medical information, patient medical records, medical legal information, and medical equipment information transmitted between the remote support terminal and the on-site support portal.

3. The system of claim 1, wherein the output component of the remote support terminal and the input component of the on-site support portal include visual and audio components such that the video and audio of the medical procedure includes the hospital physician performing the medical procedure with medical equipment and communicating with the medical equipment support representative in real time.

4. The system of claim 1, wherein the input component of the remote support terminal and the output component of the on-site support portal include visual and audio components such that the video and audio of the medical equipment support representative shows equipment selected by the medical equipment support representative and includes the medical equipment support representative communicating with the hospital physician in real time.

5. The system of claim 1, wherein the output component of the remote support terminal includes a virtual reality component for presenting virtual representations of the medical procedure, equipment selected by the hospital physician, or other information presented by the hospital physician to the medical equipment support representative.

6. The system of claim 1, wherein the input component of the remote support terminal includes a virtual reality component for allowing the medical equipment support representative to present equipment information to the hospital physician via manipulations of virtual representations of selected equipment.

7. The system of claim 1, wherein the output component of the on-site support portal includes a virtual reality component for presenting representations of medical equipment information selected by the medical equipment support representative.

8. The system of claim 7, wherein the virtual reality component comprises a virtual reality projector configured to project a virtual equipment tray template for the hospital physician to reference.

9. The system of claim 8, wherein the virtual reality project comprises a remote controlled pointer for pointing to virtual images on the equipment tray template, the remote controlled pointer configured to be controlled by the equipment support representative over the wireless communication network.

10. The system of claim 1, wherein the input component of the on-site support portal includes a virtual reality component for allowing the hospital physician to present medical procedure information and medical equipment information to the medical equipment support representative via manipulations of virtual representations of biological parts, biological systems, and/or medical equipment.

11. A method of providing medical equipment support to a hospital physician performing a medical procedure on a patient in a medical treatment room, the method comprising the steps of:
generating video and/or audio of the medical procedure via an on-site support portal;
transmitting the video and/or audio of the medical procedure over a wireless communication network to a remotely located medical equipment support representative;
presenting the video and/or audio of the medical procedure to the remotely located medical equipment support representative via a remote support terminal;
generating a video and/or audio of the medical equipment support representative via the remote support terminal;
transmitting the video and/or audio of the medical equipment support representative over the wireless communication network to the medical treatment room; and
presenting the video and/or audio of the medical equipment support representative to the hospital physician via the on-site support portal such that the medical equipment support representative and the hospital physician communicate with each other over the wireless communication network.

12. The method of claim 11, further comprising storing medical information, patient medical records, medical legal information, and medical equipment information transmitted between the remote support terminal and the on-site support portal on a remote server system operated by a third party.

13. The method of claim 11, further comprising the step of focusing a video camera of the on-site support portal on the patient so that the medical equipment support representative views the medical procedure in real time.

14. The method of claim 11, further comprising the step of focusing a video camera of the on-site support portal on medical equipment in the medical treatment room so that the medical equipment support representative instructs the hospital physician on selection and/or use of the medical equipment in the medical treatment room.

15. The method of claim 11, further comprising the step of focusing a video camera of the remote support terminal on medical equipment or representations of medical equipment of the medical equipment support representative so that the hospital physician views the medical equipment or representations of medical equipment of the medical equipment support representative.

16. The method of claim 11, further comprising the step of presenting virtual representations of the medical procedure to the medical equipment support representative via a virtual reality output component of the remote support terminal.

17. The method of claim 11, further comprising the step of manipulating virtual representations of selected equipment via a virtual reality input component of the remote support terminal for presenting equipment information to the hospital physician.

18. The method of claim 11, further comprising the step of projecting an equipment tray template for the hospital physician to reference via a virtual reality output component of the on-site support portal.

19. The method of claim 18, further comprising the step of pointing to virtual images on the equipment tray template via a remote controlled pointer of the on-site support portal.

20. A system for providing medical equipment support to a hospital physician performing a medical procedure on a patient in a medical treatment room, the system comprising:
a remote server system including:
a processor for hosting a medical support website, the processor being configured to communicate with other electronic devices over a wireless communication network; and
a memory component for storing medical information, patient medical records, medical legal information, and medical equipment information;
a remote support terminal including:
visual, audio, and virtual reality output components configured to present video, audio, and virtual reality representations of the medical procedure and medical equipment available for the medical procedure to a remotely located equipment support representative; and
visual, audio, and virtual reality input components configured to capture video, audio, and movement of the equipment support representative and remote equipment, the remote support terminal being configured to transmit video, audio, and virtual reality representations from the input components to the medical treatment room; and
an on-site support portal including:
visual, audio, and virtual reality output components configured to present a video, audio, and virtual reality representations of the equipment support representative, the components including a virtual reality projector configured to project an equipment tray template for the physician to reference and a remote controlled pointer configured to point to images on the equipment tray template, the remote controlled pointer being controlled by the equipment support representative over the wireless communication network; and
visual, audio, and virtual reality input components configured to capture video, audio, and movement of the physician, patient, and on-site equipment and implants, the on-site support portal being configured to transmit video, audio, and virtual reality representations from the input components of the on-site support portal to the remote support terminal.
